(19) United States
(12) Patent Application Publication
(10) Pub. No.: US 2020/0180902 A1
(43) Pub. Date: Jun. 11, 2020

(54) ELASTICITY CHANGEABLE STRUCTURE OF CURTAIN REELING DEVICE

(71) Applicant: Supreme Plastic Products Co., Ltd., Qingyuan City (CN)

(72) Inventor: Song-Li Zheng, Guangdong (CN)

(21) Appl. No.: 16/215,744

(22) Filed: Dec. 11, 2018

(51) Int. Cl. B65H 75/48

(52) U.S. Cl. CPC B65H 75/486; E06B 9/322

(57) ABSTRACT

An elasticity changeable structure of a curtain reeling device contains: a main tension wheel, a first drive wheel, an auxiliary tension wheel, and a second drive wheel. The main tension wheel includes a spiral spring rolled on the main tension spring and abutting against the auxiliary tension wheel, and an operation rope are rolled on the first and second drive wheels respectively. The spiral spring includes an elasticity section having a fixed part made in a common curvature, a buffer part made in an increased curvature, a first resisting part made in a decreased curvature, a second resisting part made in a lowest curvature, and a fixing part formed on a distal end of the second resisting part. An elasticity of the second resisting part is more than the first resisting part, and an elasticity of the first resisting part is more than the buffer part.

### FIELD OF THE INVENTION

The present invention relates to an elasticity changeable structure of a curtain reeling device which contains a spiral spring having multiple curvatures and elasticities to roll or drop the curtain easily and to fix the curtain accurately.

### BACKGROUND OF THE INVENTION

A conventional curtain reeling device is applied to roll the curtain upward or to drop the curtain downward.

Referring to FIGS. 1-2, the curtain reeling device 2 contains: a main tension wheel 21, a first drive wheel 211 located beside the main tension wheel 21 to mesh with and to drive the main tension wheel 21 to rotate, an auxiliary tension wheel 22 separated from the first drive wheel 211 by the main tension wheel 21, a second drive wheel 221 located beside the auxiliary tension wheel 22 to mesh with and to drive the main tension wheel 22 to rotate, and the second drive wheel 221 being separated from the main tension wheel 21 by the auxiliary tension wheel 22.

A spiral spring 3 is rolled on the main tension wheel 21 and its distal end is fixed on the auxiliary tension wheel 22, wherein two ends of an operation rope 23 are rolled on the first drive wheel 211 and the second drive wheel 221 so as to be pulled by a pull string to drive the spiral spring 3 to be pulled out of the main tension wheel 21, and when the operation rope 23 is released by the pull string, the spiral spring 3 is released back to the main tension wheel 21.

The spiral spring 3 is made of a steel sheet in a fixed curvature. As shown in FIG. 3-A, a width of the spiral spring 3A is 12.7 mm, a length of the spiral spring 3A is 2,200 mm, a curvature of a diameter of the spiral spring 3A is 13 mm, and the spiral spring 3A has a fixed elasticity.

As illustrated in FIG. 5, when the spiral spring 3 has a small curvature and a large elasticity, the auxiliary wheel 22 is not pulled by the operation wheel 23, the spiral spring 3 supports the curtain firmly. As shown in FIG. 6, when the curtain is pulled downward, the pull string and control elements friction the curtain to reduce a load of the curtain, hence the spiral spring 3 pulls the curtain to bounce upward, and the curtain is pulled by the user with large pulling force. As illustrated in FIG. 7, when the curtain is pushed upward by a user, the spiral spring 3 is driven to roll toward the main tension wheel 21, but the curtain suddenly bounces upward and cannot be stopped at a desired position after the user stops pushing the curtain upward.

Referring to FIG. 5, when the spiral spring 3 has a large curvature and a small elasticity and the auxiliary tension wheel 22 is not pulled by the operation rope 23, the spiral spring 33 cannot support the curtain, and the curtain drops downward easily.

As illustrated in FIG. 6, when the curtain is pulled downward, the pull string and the control elements frictions the curtain so as to reduce the load of the curtain, the spiral spring 3 extends out of the main tension wheel 21 so that the user pulls the curtain downward easily, but the curtain cannot be fixed at the desired position after stopping pulling the curtain downward.

As shown in FIG. 7, when the user holds and pushes the curtain upward after dropping the curtain, the spiral spring 33 is rolled toward the main tension wheel 21 from the auxiliary tension wheel 22, so the curtain cannot be pulled by the spiral spring 33 sufficiently and cannot be fixed to the desired position exactly.

Accordingly, when the spiral spring is made in the fixed curvature, the curtain is pulled with large pulling force, bounces upward easily, and cannot be fixed at the desired position exactly.

The present invention has arisen to mitigate and/or obviate the afore-described disadvantages.

### SUMMARY OF THE INVENTION

The primary aspect of the present invention is to provide an elasticity changeable structure of a curtain reeling device which contains a spiral spring having multiple curvatures and elasticities to roll or drop the curtain easily and to fix the curtain accurately.

To obtain the above aspect, an elasticity changeable structure of a curtain reeling device provided the present invention contains: a main tension wheel, a first drive wheel located beside the main tension wheel to mesh with and to drive the main tension wheel to rotate, an auxiliary tension wheel separated from the first drive wheel by the main tension wheel, and a second drive wheel located beside the auxiliary tension wheel to mesh with and to drive the auxiliary tension wheel to rotate, the second drive wheel being separated from the main tension wheel by the auxiliary tension wheel, the main tension wheel including a spiral spring rolled on the main tension spring and a distal end of the spiral spring abutting against the auxiliary tension wheel, and two ends of an operation rope being rolled on the first drive wheel and the second drive wheel respectively.

The spiral spring is made of an elongated steel sheet and includes an elasticity section having a fixed part made in a common curvature, a buffer part made in an increased curvature and integrally connected with a rear end of the fixed part, a first resisting part made in a decreased curvature to enhance a tension of the spiral spring and integrally connected with a rear end of the buffer part, a second resisting part made in a lowest curvature and integrally connected with a rear end of the first resisting part, and a fixing part formed on a distal end of the second resisting part away from the first resisting part.

The spiral spring is rolled on the main tension spring and the distal end thereof abuts against the auxiliary tension wheel, wherein an elasticity of the second resisting part is more than the first resisting part, and an elasticity of the first resisting part is more than the buffer part.

When the auxiliary wheel is not pulled by the operation rope, the second resisting part of the spiral spring urges the main tension wheel in a largest elasticity to support the curtain which is rolled.

When the curtain is pulled downward, the pull string and control elements friction the curtain to reduce a load of the curtain. In the meantime, the first resisting part of the spiral spring extends out of the main tension wheel in the decreased curvature in a second elasticity less than the largest elasticity to avoid the curtain bouncing upward.

When the curtain is pulled downward continuously or completely, the load of the curtain is decreased to a lowest value, and the buffer part extends out of the main tension wheel in the increased curvature in a third elasticity less than the second elasticity to avoid the curtain bouncing upward and to obtain labor-saving operation.

### BRIEF DESCRIPTION OF THE DRAWINGS

FIG. 1 is a perspective view showing the exploded components of an elasticity changeable structure of a curtain reeling device according to a preferred embodiment of the present invention.

FIG. 1-A is a perspective view showing the exploded components of a part of the elasticity changeable structure of the curtain reeling device according to the preferred embodiment of the present invention.

FIG. 2 is a perspective view showing the assembly of the elasticity changeable structure of the curtain reeling device according to the preferred embodiment of the present invention.

FIG. 3 is a side plan view showing the assembly of a conventional spiral spring.

FIG. 3-A is a schematic view showing a size of the conventional spiral spring.

FIG. 4 is a side plan view showing the assembly of a spiral spring of the elasticity changeable structure of the curtain reeling device according to the preferred embodiment of the present invention.

FIG. 4-A is a schematic view showing a size of the spiral spring of the elasticity changeable structure of the curtain reeling device according to the preferred embodiment of the present invention.

FIG. 5 is a top plan view showing the operation of the elasticity changeable structure of the curtain reeling device according to the preferred embodiment of the present invention.

FIG. 6 is another top plan view showing the elasticity changeable structure of the curtain reeling device according to the preferred embodiment of the present invention.

FIG. 7 is also another top plan view showing the elasticity changeable structure of the curtain reeling device according to the preferred embodiment of the present invention.

### DETAILED DESCRIPTION OF THE PREFERRED EMBODIMENTS

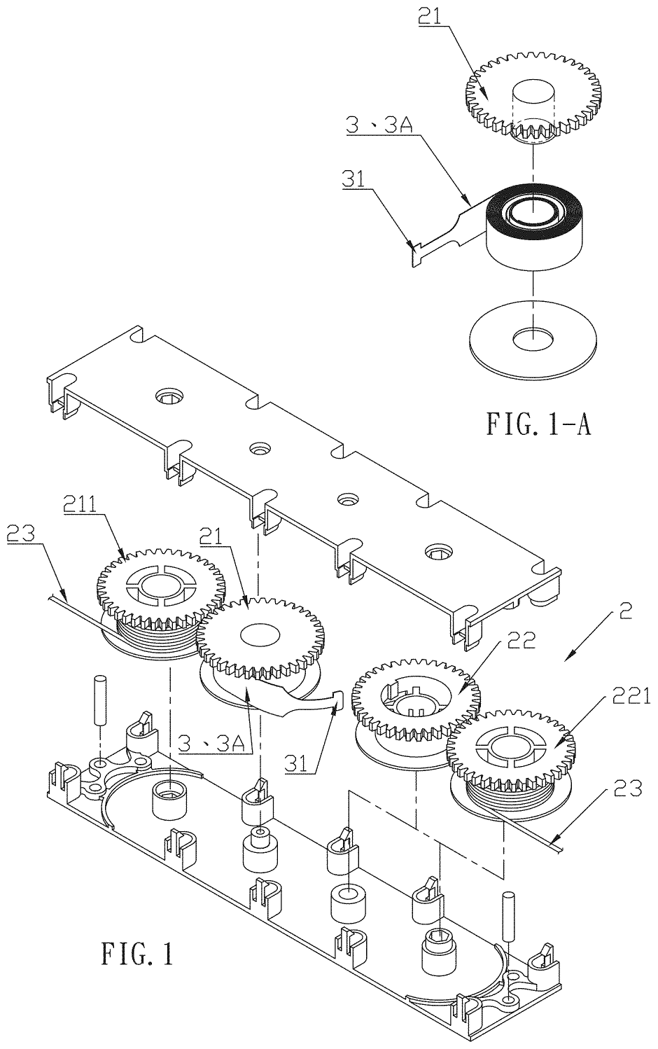

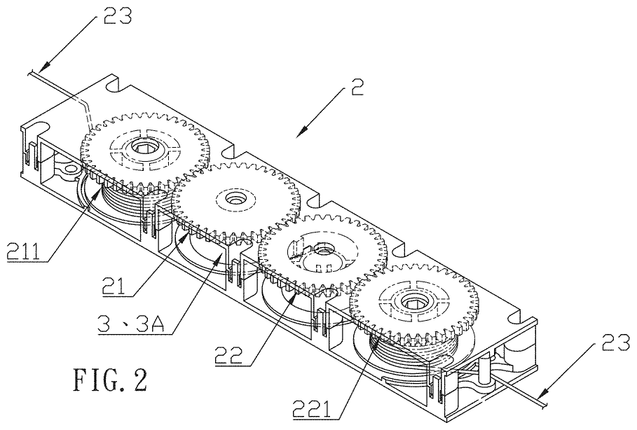

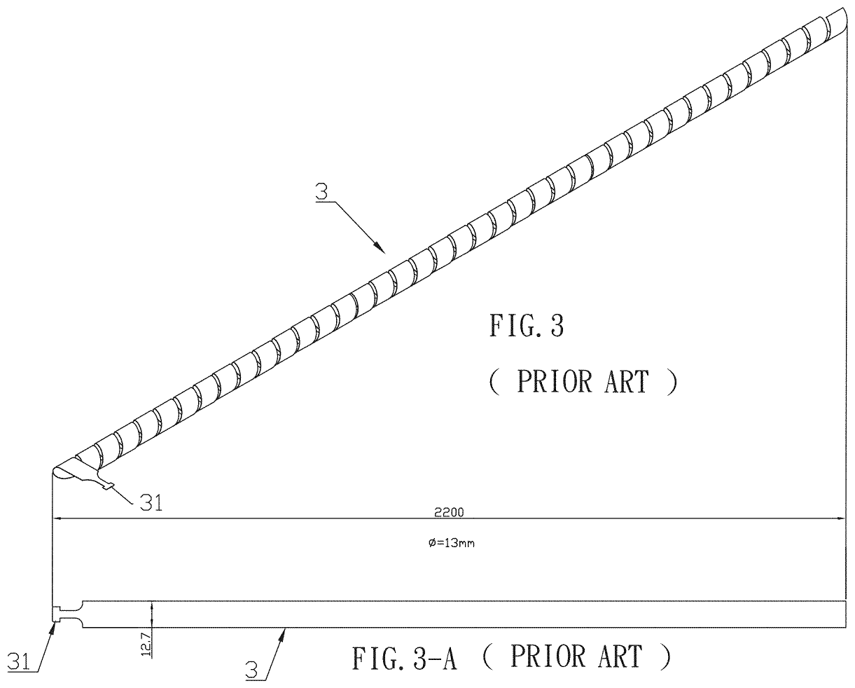

With reference to FIGS. 1-4A, an elasticity changeable structure of a curtain reeling device according to a preferred embodiment of the present invention comprises:

a main tension wheel 21, a first drive wheel 211 located beside the main tension wheel 21 to mesh with and to drive the main tension wheel 21 to rotate, an auxiliary tension wheel 22 separated from the first drive wheel 211 by the main tension wheel 21, a second drive wheel 221 located beside the auxiliary tension wheel 22 to mesh with and to drive the auxiliary tension wheel 22 to rotate, and the second drive wheel 221 being separated from the main tension wheel 21 by the auxiliary tension wheel 22, the main tension wheel 21 includes a spiral spring 3A rolled on the main tension spring 21 and a distal end of the spiral spring 3A abutting against the auxiliary tension wheel 22, and two ends of an operation rope 23 are rolled on the first drive wheel 211 and the second drive wheel 221 respectively, wherein when the curtain is rolled or is released, the operation rope 23 is pulled by a pull string of the curtain to pull the spiral spring 3A outward around the main tension wheel 21, such that the operation rope 23 is urged by the spiral spring 3A to release.

The spiral spring 3A is made of an elongated steel sheet and includes an elasticity section having multiple curvatures, for example, the elasticity section of the spiral spring 3A has a fixed part 3A1 made in a common curvature, a buffer part 3A2 made in an increased curvature and integrally connected with a rear end of the fixed part 3A1, a first resisting part 3A3 made in a decreased curvature to enhance a tension of the spiral spring 3A and integrally connected with a rear end of the buffer part 3A2, a second resisting part 3A4 made in a lowest curvature and integrally connected with a rear end of the first resisting part 3A3, and a fixing part 31 formed on a distal end of the second resisting part 3A4 away from the first resisting part 3A3.

The spiral spring 3A is rolled on the main tension spring 21 and the distal end thereof abuts against the auxiliary tension wheel 22, wherein an elasticity of the second resisting part 3A4 is more than the first resisting part 3A3, and an elasticity of the first resisting part 3A3 is more than the buffer part 3A2.

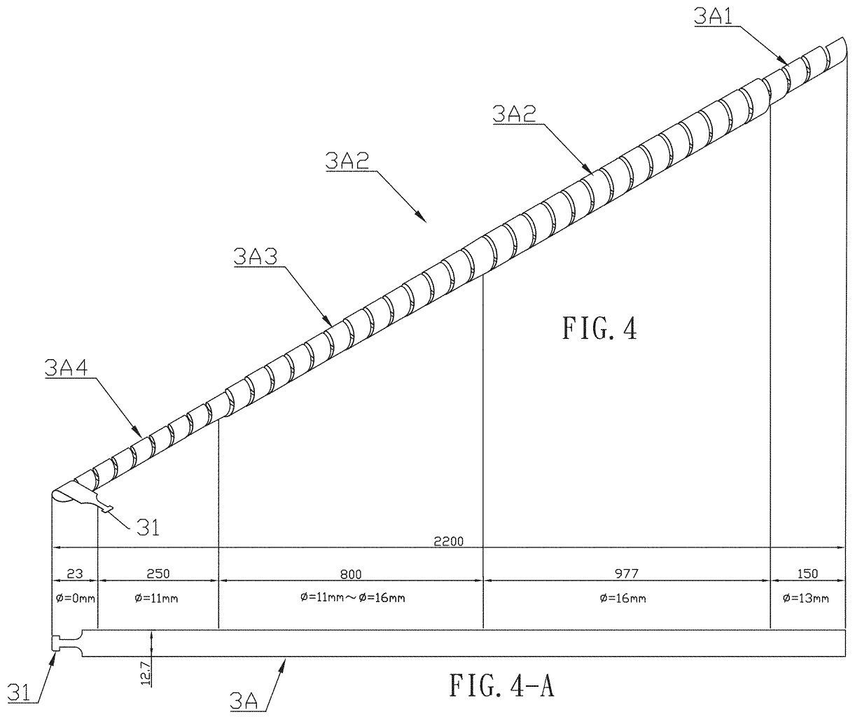

Referring to FIGS. 4 and 4-A, a width of the spiral spring 3A is 12.7 mm, and a length of the spiral spring is 2,000 mm. A length of the fixed part 3A1 is 150 mm, the common curvature of a diameter of the fixed part 3A1 is 13 mm, and the fixed part 3A1 is rolled on the main tension wheel 21. A length of the buffer part 3A2 is 977 mm, and the increased curvature of a diameter of the buffer part 3A2 is 16 mm. A length of the first resisting part 3A3 is 800 mm, and the decreased curvature of a diameter of the buffer part 3A2 is within 11 mm to 16 mm. A length of the second resisting part 3A4 is 250 mm, and the lowest curvature of a diameter of the second resisting part 3A4 is 11 mm. Furthermore, a length of the fixing part 31 is 23 mm.

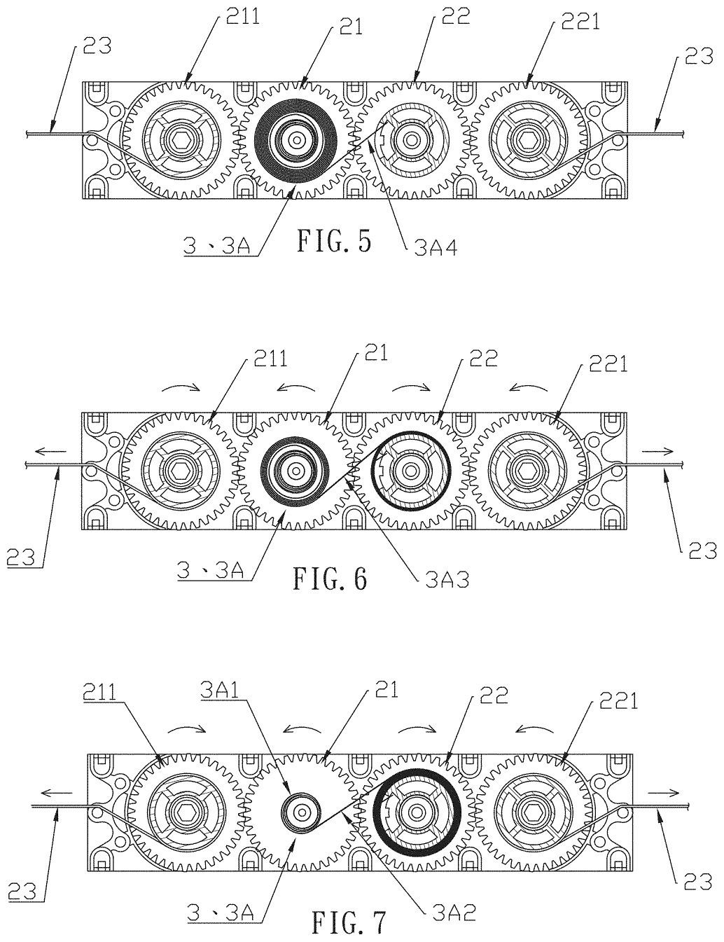

As shown in FIG. 5, when the auxiliary wheel 22 is not pulled by the operation rope 23, the second resisting part 3A4 of the spiral spring 3A urges the main tension wheel 21 in a largest elasticity to support the curtain which is rolled.

As illustrated in FIG. 6, when the curtain is pulled downward, the pull string and control elements friction the curtain to reduce a load of the curtain. In the meantime, the first resisting part 3A3 of the spiral spring 3A extends out of the main tension wheel 21 in the decreased curvature in a second elasticity less than the largest elasticity to avoid the curtain bouncing upward.

With reference to FIG. 7, when the curtain is pulled downward continuously or completely, the load of the curtain is decreased to a lowest value, and the buffer part 3A2 extends out of the main tension wheel 21 in the increased curvature in a third elasticity less than the second elasticity to avoid the curtain bouncing upward and to obtain labor-saving operation.

When the curtain is held upward by a user, the spiral spring 3A is rolled back to the main tension wheel 21A from the auxiliary tension wheel 22. For example, the buffer part 3A2 (as shown in FIG. 7), the first resisting part 3A3 (as illustrated in FIG. 6), and the second resisting part 3A4 (as shown in FIG. 5) of the spiral spring 3A are rolled back to the main tension wheel 21A from the auxiliary tension wheel 22 in turn, thus avoiding the curtain bouncing upward or dropping downward and obtaining the labor-saving operation.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention

What is claimed is:

1. An elasticity changeable structure of a curtain reeling device comprising:
a main tension wheel, a first drive wheel located beside the main tension wheel to mesh with and to drive the main tension wheel to rotate, an auxiliary tension wheel separated from the first drive wheel by the main tension wheel, and a second drive wheel located beside the auxiliary tension wheel to mesh with and to drive the auxiliary tension wheel to rotate, the second drive wheel being separated from the main tension wheel by the auxiliary tension wheel, the main tension wheel including a spiral spring rolled on the main tension spring and a distal end of the spiral spring abutting against the auxiliary tension wheel, and two ends of an operation rope being rolled on the first drive wheel and the second drive wheel respectively;
wherein the spiral spring is made of an elongated steel sheet and includes an elasticity section having a fixed part made in a common curvature, a buffer part made in an increased curvature and integrally connected with a rear end of the fixed part, a first resisting part made in a decreased curvature to enhance a tension of the spiral spring and integrally connected with a rear end of the buffer part, a second resisting part made in a lowest curvature and integrally connected with a rear end of the first resisting part, and a fixing part formed on a distal end of the second resisting part away from the first resisting part;
wherein the spiral spring is rolled on the main tension spring and the distal end thereof abuts against the auxiliary tension wheel, wherein an elasticity of the second resisting part is more than the first resisting part, and an elasticity of the first resisting part is more than the buffer part.
